(19) United States
(12) Patent Application Publication
(10) Pub. No.: US 2026/0064253 A1
(43) Pub. Date: Mar. 5, 2026

(54) METHOD, APPARATUS, STORAGE MEDIUM AND ELECTRONIC DEVICE FOR INFORMATION DISPLAY

(71) Applicants: Beijing Youzhuju Network Technology Co., Ltd., Beijing (CN); Lemon Inc., Grand Cayman (KY)

(72) Inventors: Dingwei Qian, Beijing (CN); Fulin Li, Los Angeles, CA (US); Binglin Zhang, Beijing (CN); Xianyang Leng, Beijing (CN); Huiling Mu, Beijing (CN); Qiong Wu, Beijing (CN); Zhitian Fu, Beijing (CN); Jiahao Chen, Beijing (CN); Kewei Du, Beijing (CN)

(21) Appl. No.: 18/974,164

(22) Filed: Dec. 9, 2024

(30) Foreign Application Priority Data
Aug. 30, 2024 (CN) 202411216746.6

(51) Int. Cl. G06F 3/04842; G06F 16/22

(52) U.S. Cl. CPC G06F 3/04842; G06F 16/2246

(57) ABSTRACT

The embodiment of the invention provides methods, devices, storage medium and electronic devices for information display. Wherein the method includes: displaying a system page, including a keyword and a non-keyword, wherein the keyword is provided with a preset mark and determined by matching in a preset keyword library including a plurality of preconfigured keywords and association information corresponding to each of the keyword; and displaying, in response to a trigger on the keyword, the association information corresponding to the keyword on the system page. According to the disclosure, by preconfiguring the preset keyword library, the plurality of keywords and the association information corresponding to the keywords are maintained, and flexible configuration of the keywords is realized; the association information corresponding to the keywords is dynamically displayed in the system page, thus the interactivity and convenience of display of the association information are improved.

### CROSS-REFERENCE

The present application claims priority to Chinese Patent Application No. 202411216746.6, filed on Aug. 30, 2024 and entitled “METHOD, APPARATUS, STORAGE MEDIUM AND ELECTRONIC DEVICE FOR INFORMATION DISPLAY”, the entirety of which is incorporated herein by reference.

### FIELD

Embodiments of the present disclosure relate to information processing technologies, and in particular, to a method, apparatus, storage medium, and electronic device for information display.

### BACKGROUND

In complex business systems, professional terms and business concepts play a vital role in the operation of system users. The traditional term management mode mainly depends on static documents, manuals or training, etc., however there are problems of not timely updating, long learning time, difficulty in quick query and the like.

### SUMMARY

The present disclosure provides a method, device, storage medium and electronic device for information display, in order to dynamically display the association information of keywords on a system page.

According to a first aspect, embodiments of the present disclosure provide an information display method, comprising: displaying a system page comprising a keyword and a non-keyword, wherein a preset mark is set for the keyword and the keyword is determined by matching in a preset keyword library comprising a plurality of preconfigured keywords and association information corresponding to each of the keywords; in response to a trigger on the keyword, displaying the association information corresponding to the keyword in the system page.

According to a second aspect, embodiments of the present disclosure further provide an apparatus for information display, comprising: a page display module, configured to display a system page, comprising a keyword and a non-keyword, wherein the keyword is provided with a preset mark and determined by matching in a preset keyword library comprising a plurality of preconfigured keywords and an association information corresponding to each of the keywords; an information display module, configured to display, in response to a trigger on the keyword, the association information corresponding to the keyword in the system page.

According to a third aspect, embodiments of the present disclosure further provide an electronic device, comprising: one or more processors; a storage device, configured to store one or more programs, the one or more programs, when executed by the one or more processors, causing the one or more processors to implement the information display method according to any embodiments of the present disclosure.

According to a fourth aspect, embodiments of the present disclosure further provide a storage medium comprising computer-executable instructions, the computer-executable instructions, when executed by a computer processor, configured to perform the information display method according to any embodiments of the present disclosure.

According to the present disclosure, by preconfiguring the preset keyword library, the plurality of keywords and the association information corresponding to the keywords are maintained, and flexible configuration of the keywords is realized. In the display process of any system page, the keyword displayed in the system page is determined by matching in the preset keyword library, and the keyword is set with a preset mark in order to prompt the user with the keyword and determine the keyword in the system page dynamically without editing the page script of the system page. During the display process of the system page, in response to the trigger of the keyword, the association information corresponding to the keyword is dynamically displayed in the system page, thus the interactivity and convenience of display of the association information are improved, and the query process of the association information corresponding to the keywords is simplified.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, where components and elements are not necessarily drawn to scale.

FIG. 1 is a schematic flowchart of an information display method according to an embodiment of the present disclosure;

FIG. 2 is a schematic diagram of a system page according to an embodiment of the present disclosure;

FIG. 3 is a schematic diagram of displaying association information of a keyword according to an embodiment of the present disclosure;

FIG. 4 is a schematic structural diagram of an information display apparatus according to an embodiment of the present disclosure; and

FIG. 5 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and instead these embodiments provided herein are intended for a more thorough and complete understanding of the present disclosure. It should be understood that the drawings and embodiments of the present disclosure are for exemplary purposes only and are not intended to limit the scope of the present disclosure.

It should be understood that the steps recited in the method implementations of the present disclosure may be performed in different orders, and/or in parallel. Further, the method implementations may comprise additional steps and/or omit performing the illustrated steps. The scope of the present disclosure is not limited in this respect.

As used herein, the term “comprising/including” and variations thereof are open-ended, i.e., “comprising/including but not limited to”. The term “based on” is “based at least in part on”. The term “one embodiment” means “at least one embodiment”; the term “another embodiment” means “at least one other embodiment”; the term “some embodiments” means “at least some embodiments”. The relevant definitions of other terms will be given below.

It should be noted that the concepts such as “first” and “second” mentioned in this disclosure are merely used to distinguish different apparatuses, modules, or units, and are not intended to limit the order or the mutual dependency relationship of functions performed by the apparatuses, modules, or units.

It should be noted that the modification of “one” and “a plurality of” mentioned in this disclosure is illustrative and not limiting, and those skilled in the art should understand that it should be understood as “one or more” unless the context clearly indicates otherwise.

The names of messages or information exchanged between multiple apparatuses in embodiments of the present disclosure are for illustrative purposes only and are not intended to limit the scope of such messages or information.

It can be understood that, before the technical solutions disclosed in the various embodiments of the present disclosure are used, the types, the usage scope, the usage scenarios and the like of personal information related to the present disclosure should be notified to the user and obtain the authorization of the user in an appropriate manner according to the relevant laws and regulations.

For example, in response to receiving an active request from a user, send a prompt information to the user to explicitly prompt the user that the requested operation will need to acquire and use the personal information of the user. Therefore, the user is enabled to autonomously select whether to provide personal information to software or hardware executing the operation of the technical solution of the present disclosure according to the prompt information.

As an optional but non-limiting implementation, in response to receiving the active request of the user, the manner of sending the prompt information to the user may be in a form of, for example, a pop-up window, and the prompt information may be presented in text in the pop-up window. In addition, the pop-up window may further carry a selection control for the user to select “agree” or “disagree” to provide personal information to the electronic device.

It may be understood that the foregoing notification and obtaining process of a user authorization is merely illustrative, and does not constitute a limitation on implementations of the present disclosure, and other manners of meeting related laws and regulations may also be applied to implementations of the present disclosure.

It may be understood that the data involved in the present technical solution (including but not limited to the data itself, the acquisition or use of the data) should follow the requirements of the corresponding laws and regulations and related specifications.

In order to display association information of a keyword in a page during a page display process, a page script may be formed in the form of code editing, and the keyword and the association information corresponding thereto are preset in the page script, such that if the keyword is triggered during the page display process, the association information corresponding to the keyword is displayed. However, in the above manner, there are certain limitations in the manner of code editing, and the page script needs to be re-edited if there is a change in the keyword or the association information corresponding to the keyword, thus the editing cost is high, and the difficulty is great. Accordingly, the flexibility of keyword display is poor. In view of the above technical problem, the embodiments of the present disclosure provide an information display method, which may dynamically set keywords and associated information corresponding thereto without re-editing the page script and thus simplify the information display process of the keywords.

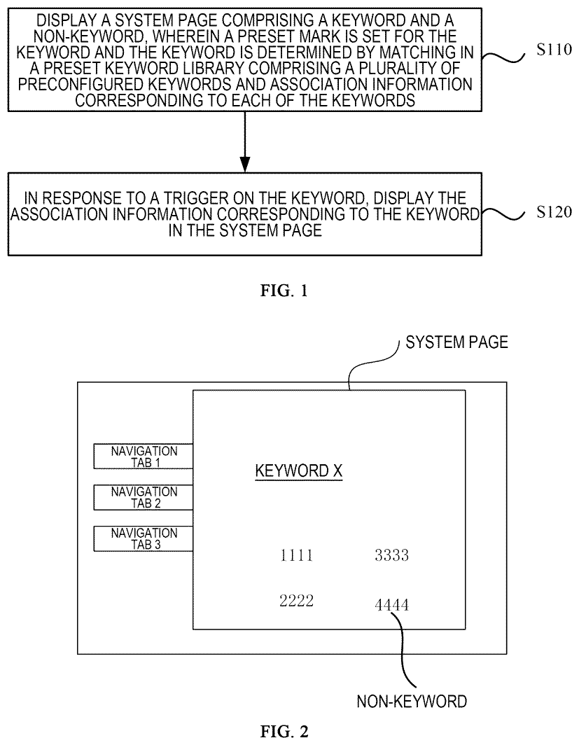

FIG. 1 is a schematic flowchart of an information display method according to an embodiment of the present disclosure, and the embodiments of the present disclosure are applicable to use a word that needs to be described in detail, such as a professional term and a business concept, as a keyword. During a display process of a system page, association information corresponding to a keyword is displayed according to a trigger on the keyword of a user, thereby implementing a scenario of dynamic on-demand display of the associated information of the keyword. The method may be performed by an information display apparatus which may be implemented in a form of software and/or hardware, and optionally, implemented by using an electronic device which may be a mobile terminal, a PC terminal, a computer, a server, or the like.

As shown in FIG. 1, the method comprises:

S110: displaying a system page comprising a keyword and a non-keyword, wherein a preset mark is set for the keyword and the keyword is determined by matching in a preset keyword library comprising a plurality of preconfigured keywords and association information corresponding to each of the keywords.

S120: in response to a trigger on the keyword, displaying the association information corresponding to the keyword in the system page.

In the embodiments, the business system may be understood as a system for implementing a business request. The business system may comprise a plurality of system pages comprising page content, and the page content may comprise a keyword and a non-keyword, where the keyword may be content that needs to be introduced, and the non-keyword may be content that does not need to be introduced. For example, the keywords may include, but are not limited to, professional terms and business concepts. The type of the business system is not limited herein, and different business systems may be set according to the business requirements. Accordingly, the keywords in different business systems are also different, and are set according to requirements such as professional terms and business concepts in the business scenario of the business system.

The keyword in the business system may be preset according to requirements. Optionally, a preset keyword library comprising keywords in the business system and association information corresponding to each keyword is set. The association information corresponding to the keyword may be detailed introduction information corresponding to the keyword.

The preset keyword library is an editable keyword library. Through operations such as creation, modification, deletion and the like, the preset keyword library may be dynamically updated, such that the flexibility of the preset keyword library is improved. Specifically, a new keyword and an association relationship corresponding to the keyword may be added through the creation operation, a stored keyword and/or association information in the preset keyword library may be modified through the modification operation, and a stored keyword and the association relationship corresponding to the keyword in the preset keyword library may be deleted through the deletion operation. There is a corresponding relationship between the keyword and the association information corresponding to the keyword in the preset keyword library and the relationship, for example, may in a form of a key-value pair, where the keyword is used as a key, and the association information corresponding to the keyword is used as a value. Alternatively, the relationship may be stored in a form of an array, where each of the keywords and the association information corresponding to the keyword are stored in an array. The storage form of the keyword and the association information in the preset keyword library is not limited herein, and the keyword and the association information may be stored in association.

In response to a trigger on the business system, a system page is displayed. The trigger on the business system includes, but is not limited to, startup of the business system, switching, refreshing and the like on a system page in the service system. The specific form of the trigger is not limited herein and the trigger, for example, may be a click, a sliding, or the like.

Each system page may comprise a plurality of pieces of page content. The pieces of page content in the system page are matched in a preset keyword library respectively. If a certain piece of page content is successfully matched in the preset keyword library, it indicates that the page content is a keyword. If the page content fails to match in the preset keyword library, it indicates that the page content is a non-keyword. In the case that the same keyword is comprised in different system pages, the keyword may be determined by matching in the preset keyword library without editing of the page scripts of different system pages, thus the flexibility of keyword setting may be improved. Meanwhile, in the case that the association information corresponding to the keyword has changed, unified modification may be achieved by modifying the association information in the preset keyword library without modification for different system pages.

In the embodiments, by maintaining the preset keyword library and storing the plurality of keywords and the association relationship corresponding to each of the keyword in the preset keyword library according to the business requirement, a data basis is provided for the information display of the keyword in the business system without re-writing of the code script of the business system, thus the flexibility of displaying the information corresponding to the keyword is improved.

On the basis of the above embodiments, the keyword in the system page is set with a preset mark for distinguishingly displaying the keyword in the system page, so as to prompt the user. Optionally, the preset mark of the keyword may be a text attribute mark, such as for example, one or more of a text color mark, a background color mark, a text modification mark, or a text shadow mark. For example, the color of the keyword is different from the color of the non-keyword, or the font type of the keyword is different from the font type of the non-keyword, or the font size of the keyword is greater than the font size of the non-keyword, or the keyword is set to be inclined, or the keyword is underlined, or the keyword is set with a background color or a shadow.

Optionally, the system page is displayed by: obtaining an object node tree corresponding to the system page, wherein the object node tree comprises a plurality of object nodes, and each of the object nodes corresponds to a piece of page content; traversing the plurality of object nodes in the object node tree, matching the piece of page content corresponding to each of the object nodes in the preset keyword library, and determining the successfully matched piece of page content as a keyword; and rendering the plurality of object nodes in the object node tree to form the system page, wherein the preset mark is set for the keyword determined by the matching during the rendering.

In the embodiments, each system page may correspond to an object node tree. The object node tree comprises a plurality of object nodes, where the object nodes may include a root node and a child node. Herein, the object node may be a dom node. Each dom node corresponds to a piece of page content. In response to the trigger in the system page, the object node tree corresponding to the system page is obtained. Each object node in the object node tree is traversed, and the page content corresponding to each object node is matched in a preset keyword library. In a case that the page content or a portion of the page content is successfully matched with the stored keywords in the preset keyword library, the page content or the portion of the page content is determined as the keyword. In a case that the page content fails to match the stored keywords in the preset keyword library, the page content is determined as a non-keyword.

Each object node in the object node tree is rendered, and a preset mark is set for the successfully matched keyword to form the system page. Optionally, the preset mark is set for the keyword through the CSS Highlighter interface, without changing of the structure of the object node, so that non-invasive page rendering may be realized, and the potential compatibility problem is reduced. Specifically, setting the preset mark for the keyword determined by the matching comprises: creating a text area object corresponding to the keyword; creating a mark object corresponding to the keyword; and assigning the text area object corresponding to the keyword to the mark object corresponding to the keyword, and registering the mark object, wherein the mark object corresponds to a respective mark attribute.

The text area object may be a range object, and the text area object may be a continuous text area, wherein the range of the text area may be determined according to the number of texts of the keyword. The mark object may be a Highlighter object, wherein different mark manners may correspond to different mark objects. Correspondingly, the preset mark of the keyword is created according to the mark type of the keyword, wherein the mark type of the keyword may be preset in the preset keyword library. In some embodiments, the mark types corresponding to different keywords may be the same or different and may be determined according to display requirements of the keywords. The preset keyword library further comprises a mark type corresponding to each keyword, and the mark type may be represented by identifiers such as 0, 1, 2, A, B, and the like. In a case that the keyword matching is successful, the mark type corresponding to the keyword is read to create a corresponding mark object.

The range object is assigned to the mark object corresponding to the keyword, and the mark object is registered. The mark object is provided with a highlighting style by using a marking pseudo-elements, where the highlighting style may be a marking attribute of a preset mark. The marking attribute may be, for example, a font color, a background color, an underline, or the like.

For example, referring to FIG. 2 which is a schematic diagram of a system page according to an embodiment of the present disclosure. The system page comprises a keyword X, which is underlined for distinguishing non-keywords in the system page. The keyword may be prompted by the preset mark. It may be understood that the interactive interface of the business system may comprise a navigation area and a system page. The navigation area may comprise navigation tabs, and each navigation tab may correspond to a different system page respectively. The system page may be switched through selection on the navigation tab, and the preset mark may be set for the keyword in the switched system page.

In some embodiments, the preset keyword library may be stored in the server. In response to a trigger in the system page, keywords in the preset keyword library and association information corresponding to the keyword are read from the server. The above process may be implemented by a data pulling function and a data formatting function. Specifically, a keyword and association information corresponding to the keyword in a preset keyword library are pulled from the server through a data pulling function, and the pulled data is converted into a structure tree object in a uniform format through a data formatting function and stored.

In the foregoing embodiments, before obtaining the keyword and the association information corresponding to the keyword in the preset keyword library from the server, the method further comprises: determining whether the system page belongs to a whitelist page. A whitelist is preset and comprises a page identifier of at least one system page, and the page identifier may be a URL address. A system page in the whitelist is a whitelist page, and a page not in the whitelist is a non-whitelist page. The whitelist page is a page providing display of a keyword mark and keyword information, and the non-whitelist page is a page that does not provide display of a keyword mark and keyword information. The business system comprises a plurality of system pages, and the whitelist page may be set according to a business requirement. With the setting of the non-whitelist page, the interference of display of the keyword mark and the keyword information in the non-whitelist page for the business implementation process may be avoided.

In the foregoing embodiments, before obtaining the keyword in the preset keyword library and the association information corresponding to the keyword from the server, the method further comprises: determining whether the system page supports a keyword mark. If yes, the method continues to obtain the keyword and the association information corresponding to the keyword in the preset keyword library from the server. If the system page does not support the keyword mark, the step of obtaining the keyword and the association information corresponding to the keyword in the preset keyword library from the server is not needed to be performed, and the plurality of object nodes in the object node tree are directly rendered. If the system page supports the keyword mark, the step of obtaining the keyword and the associated information corresponding to the keyword in the preset keyword library from the server is performed, and the preset mark is set for the keyword during the process of rendering the plurality of object nodes in the object node tree. A specific field corresponding to the system page may be read and the field indicates whether the keyword mark is supported. For example, in a case that the field content of the specific field is 1, it is indicated that the system page supports the keyword mark. In a case that the field content of the specific field is 0, it is indicated that the system page does not support the keyword mark.

On the basis of the foregoing embodiments, during the display process of the system page, the page content displayed in the system page may change through the interaction of the user. That is, the object nodes corresponding to the system page may change, the number of keywords corresponding to the system page may be increased or decreased accordingly. The changed keyword may be updated by monitoring the change in the system page. For example, a preset mark may be set for a newly added keyword, thereby improving the real-time performance of keyword display in the system page.

Optionally, the change of an object node corresponding to the system page is monitored, and in accordance with a determination that a number of changed object nodes exceeds a set threshold, the pieces of page content corresponding to the changed object nodes are matched in the preset keyword library, and the successfully matched piece of page content is determined as a keyword, and a preset mark is set for the keyword.

By obtaining the object node at the current moment and comparing the object node at the current moment with the object node at the previous moment, the number of object nodes at the current moment that are different from those in the object node at the previous moment is determined. The object node at the current moment that is not the same as the object node at the previous moment is determined as a changed object node, and the number of the changed object nodes is compared with a set threshold. In accordance with a determination that a number of changed object nodes exceeds a set threshold, the recognition and the mark of the keyword are triggered. Specifically, by matching the page content of the changed object node in the preset keyword library, the successfully matched page content is determined. The keyword is determined based on the successfully matched page content and a preset mark is set for the keyword. The manner in which the preset mark is set for the keyword is the same as that in the foregoing description, and details are not described herein again.

In the embodiments, by setting the preset threshold as the trigger condition for keyword recognition and marking, the interference of frequent triggering for normal business processing in the system page may be avoid.

In the foregoing embodiments, there may be page jitter during the display process of the system page, and the page jitter may cause the object node corresponding to the system page to change, resulting in frequent operation of keyword recognition and marking, and the performance of the system page is affected. Accordingly, the object node is de-jittered in the case that the trigger condition of keyword recognition and marking is met. The trigger condition for keyword recognition and marking may comprise the first loading of the system page and the number of changed object nodes in the system page exceeding a set threshold.

Optionally, matching the page content corresponding to the changed object node in the preset keyword library comprises: performing de-jitter processing on the object node to determine a de-jittered changed object node, and matching a piece of page content corresponding to the de-jittered changed object node in the preset keyword library.

A manner of de-jitter processing is: determining, within a preset time period, an object node at a set moment in the preset time period as a target object node, and the target object node is a de-jittered object node. The set moment may be the last moment of the preset time period, and the preset time period may be 1 seconds. That is, in accordance with a determination that a number of changed object nodes exceeds a set threshold, the target object node(s) at the last moment in the preset time period is obtained, and the de-jittered changed object node is determined in the target object node(s). A keyword is determined in the page content corresponding to the de-jitter changed object node, and a preset mark is set for the keyword.

On the basis of the foregoing embodiments, the keyword in the system page is a keyword that its information is to be displayed, such as a professional term or a business concept, and it is difficult to understand the keyword to some extent. Correspondingly, the association information corresponding to the keyword is detailed description information of the keyword, including but not limited to an English and Chinese name, a Chinese and English interpretation, and a document link corresponding to the keyword.

During the display process of the system page, the user may input a trigger on the keyword in the system page, where the trigger may be a click on the keyword, or may be a hover of the cursor at the keyword position. It may be understood that a trigger event monitor is preset and the association information corresponding to the triggered keyword is displayed in a case that a trigger on any keyword is monitored. Specifically, in an example that the trigger is the hover of the cursor, the cursor position is monitored in real time, and it is determined that the trigger operation is monitored in response to the cursor position falls within the keyword display range.

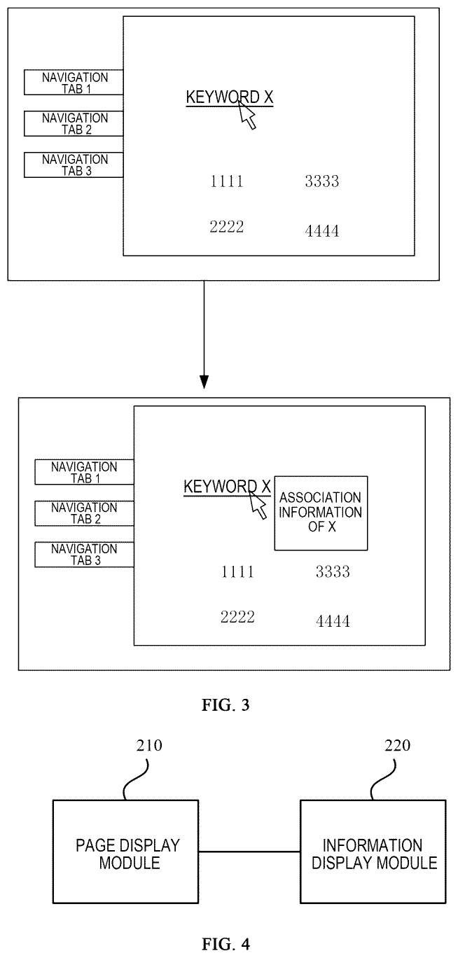

Optionally, the association information may be presented in a form of a bubble box, a pop-up window, or a floating window, and the display form of the association information is not limited herein. For example, reference is made to FIG. 3 which is a schematic diagram of displaying association information of a keyword according to an embodiment of the present disclosure.

Optionally, the display position of the association information is an association position of the keyword. The association position of the keyword may be any of the left side, the right side, the upper side or the lower side of the position of the keyword. Specifically, position information of the keyword is determined, and the association information is displayed at a display position of the association information determined according to the position information of the keyword. According to the position information of the keyword in the system page, whether the left side, the right side, the upper side and the lower side of the position of the keyword meet the display condition of the association information are determined. In accordance with a determination that the display condition of the association information is met at all position, the association information may be randomly determined to display on any side of the keyword. Or the display position of the association information is determined based on the priority. For example, the priorities of the right side, the left side, the lower side and the upper side are sequentially reduced. In a case that the right side of the keyword meets the display condition of the association information, the association information can be preferentially displayed on the right side of the keyword. The display condition of the association information may be a display area size of the key information. For example, the display area size is determined according to the data volume of the association information. Optionally, the fixed width of the display area may be preset, and the length of the display area is determined according to the data volume of the associated information. The distance from each side of the keyword to the edge of the system page is determined based on the position information of the keyword, and whether the distance from each side of the keyword to the edge of the system page meets the display area size of the key information is determined. In accordance with a determination that the display area size of the key information is met in a certain direction, it is determined that the display condition for association information is met.

Based on the foregoing embodiments, in order to avoid that the associated information is blocked during the display process, the associated information corresponding to the keyword is displayed on the uppermost layer of the system page. Optionally, the association information may be rendered to document.body through the ReactDOM.createPortal method, to ensure that the association information is displayed at the uppermost layer of the system page. On this basis, in order to minimize the blocking of the page content in the system page due to the display process of the association information, the position with a minimum blockage to the page content in the system page may be determined as the display position of the association information in the associated position of the position of the keyword.

In the embodiments, the display position of the association information is dynamically determined according to the position of the keyword in the system page, and the flexibility of displaying the association information is improved.

In the foregoing embodiments, the object node (the original object node herein) in the object node tree corresponding to the system page does not have an interaction function, and in order to dynamically display the association information corresponding to the keyword in response to the keyword is triggered, targeted processing is applied on the object node corresponding to the triggered keyword. Specifically, displaying the association information in the system page comprises: replacing the original object node corresponding to the keyword based on the interaction object node, wherein the interaction object node comprises the association information corresponding to the keyword; and rendering the interaction object node in the system page.

The interaction object node is an object node (that is, a dom node) with an interaction function, and the interaction object node is configured with association information and a rendering form of the association information, for example, a pop-up window form. By rendering the interaction object node in the system page, the association information corresponding to the keyword may be dynamically displayed, thus the interactivity and convenience of the association information query are improved, and the process of exiting the system page to query the static document is replaced.

It may be understood that the system page may comprise one or more keywords, and the probability that each keyword is triggered is different. In a case that the keyword is not triggered, the keyword is displayed based on the original object node corresponding to the system page, and in a case that the keyword is triggered, the original object node corresponding to the triggered keyword is replaced based on the interaction object. Thus enabling the display of the association information corresponding to the triggered keyword is achieved without processing on the original node corresponding to the untriggered keyword, and without modification of the structure of the object node tree corresponding to the system page. The processing cost of the display process of the association information is low and the portability is high.

Optionally, the method further comprises: hiding the association information in response to a preset operation, and replacing the interaction object node with the original object node corresponding to the keyword. The preset operation may be understood as an operation of exiting the display of the association information, and the preset operation includes, but is not limited to, a scrolling in the system page, a click outside the keyword display range and the association information display range, a movement of the cursor toward outside the keyword display range and the association information display range, and the like.

In response to the preset operation detected, the association information is hidden, that is, the display of the association information is canceled in the system page. For example, in an example where the association information is displayed in a pop-up window, the pop-up window may be an associated pop-up window. By replacing the interaction object node with the original object node corresponding to the keyword, the object node tree of the system page is restored, thereby avoiding affecting normal business execution of the system page.

In some embodiments, the system page may comprise a function switching control, and the function switching control is configured to turn on or turn off the display of the association information of the keyword. For example, in a case that the function switching control is in the on state, the association information corresponding to the keyword may be triggered to display by the trigger; and in a case that the function switching control is in the closed state, the association information corresponding to the keyword may not be triggered to display, so that the interference with the business operation due to the display of the association information by mistouching during the process of operating the system page may be avoided.

On the basis of the foregoing embodiments, the method further comprises: displaying a keyword configuration page in response to a trigger on a display area where the association information is located; and updating the preset keyword library in response to an editing on the keyword configuration page.

The trigger on the display page where the association information is located may be preset to trigger the displaying of the keyword configuration page, which is not limited herein. Optionally, the display area (for example, the pop-up window) of the association information comprises a navigation control, and the navigation control is configured to trigger the display keyword configuration page. The trigger on the display page where the association information is located may be a click on the navigation control.

The keyword configuration page may display keywords stored in the preset keyword library and associated information corresponding to the keyword. The editing of the keyword configuration page includes, but is not limited to, an editing process such as creating, modifying and deleting, and adding a keyword, modifying a keyword and/or associating information, and deleting a keyword. The updated keywords and the associated information are stored in a preset keyword library to update the preset keyword library.

In some embodiments, a buried point is set for each keyword to count a frequency at which the keyword is triggered, and a trigger frequency corresponding to each keyword is displayed on the keyword configuration page respectively. The extent of the requirement of a user for critical corresponding association information during the business processing process may be indicated by the trigger frequency corresponding to the keyword. The preset keyword library may be updated according to the trigger frequency corresponding to the keyword. For example, the keyword with the trigger frequency less than a first threshold may be deleted.

In some embodiments, during the displaying process of the system page, in response to the marking on the non-keyword, the number of times of marking the non-keyword is counted, and the marking on the non-keyword may represent the requirement for displaying the presence information of the associated information corresponding to the non-keyword. The marked non-keywords and the number of times of marking the non-keyword are displayed on the keyword configuration page. In response to the number of times that the non-keyword is marked exceeding the second threshold, the non-keyword may be set as the keyword, and added to the preset keyword library, which facilitates subsequent information query for the above non-keyword.

In the embodiments, the recognition and marking of the keywords in the system page may be performed in an idle stage of the system, thereby avoiding causing the system page to be stuck. The idle stage of the system may be a stage subsequent to the loading of the system page is completed and before the next business processing. The loading of the system page may be the first loading of the system page or the refreshing loading of the system page. Optionally, the recognition and marking of the keyword may be achieved in the idle stage with the requestIdleCallback function and the requestAnimationFrame function, in order to ensure the high optimization response and effective triggering in response to the page is completely loaded and interactable.

According to the technical solution provided by the embodiment of the invention, the plurality of keywords and the association information corresponding to the keywords are maintained by presetting the preset keyword library to enable the flexible configuration of the keywords. During the display process of any system page, the keyword displayed by the system page is determined by matching in the preset keyword library, and the preset mark is set for the keyword in order to prompt the user with the keyword, therefore the keyword in the system page is dynamically determined without editing on the page script of the system page. During the display process of the system page, in response to the trigger on the keyword, the association information corresponding to the keyword is dynamically displayed in the system page, the interactivity and convenience of display of the association information are improved, and the query process of the association information corresponding to the keyword is simplified.

FIG. 4 is a schematic structural diagram of an information display apparatus according to an embodiment of the present disclosure, wherein the apparatus comprises: a page display module 210, an information display module 220, as shown in FIG. 4.

The page display module 210 is configured to display a system page comprising a keyword and a non-keyword, wherein the keyword is provided with a preset mark and determined by matching in a preset keyword library comprising a plurality of preconfigured keywords and association information corresponding to each of the keyword;

The information display module 220 is configured to display, in response to a trigger on the keyword, the association information corresponding to the keyword in the system page.

According to the technical solution provided by the embodiment of the invention, the plurality of keywords and the association information corresponding to the keywords are maintained by presetting the preset keyword library to enable the flexible configuration of the keywords. During the display process of any system page, the keyword displayed by the system page is determined by matching in the preset keyword library, and the preset mark is set for the keyword in order to prompt the user with the keyword, therefore the keyword in the system page is dynamically determined without editing on the page script of the system page. During the display process of the system page, in response to the trigger on the keyword, the association information corresponding to the keyword is dynamically displayed in the system page, the interactivity and convenience of display of the association information are improved, and the query process of the association information corresponding to the keyword is simplified.

On the basis of the foregoing embodiment, optionally, the page display module 210 is further configured to: obtain an object node tree corresponding to the system page, the object node tree comprising a plurality of object nodes and each of the object nodes corresponding to a piece of page content; traverse the plurality of object nodes in the object node tree, match the piece of page content corresponding to each of the object nodes in the preset keyword library, and determine the successfully matched piece of page content as a keyword; and render the plurality of object nodes in the object node tree to form the system page, wherein a preset mark is set for the keyword determined by the matching during a rendering.

Optionally, the page display module 210 is further configured to: create a text area object corresponding to the keyword; create a mark object corresponding to the keyword; assign the text area object corresponding to the keyword to the mark object corresponding to the keyword, and register the mark object, wherein the mark object corresponds to a respective mark attribute.

Optionally, the page display module 210 is further configured to: monitor a change of the object nodes corresponding to the system page, and in accordance with a determination that a number of changed object nodes exceeds a set threshold, match pieces of page content corresponding to the changed object nodes in the preset keyword library, determine a successfully matched piece of page content as a keyword and setting a preset mark for the keyword.

Optionally, the page display module 210 is further configured to: perform de-jitter processing on the object node to determining a de-jittered changed object node, and match a piece of page content corresponding to the de-jittered changed object node in the preset keyword library.

On the basis of the foregoing embodiment, optionally, the information display module 220 is configured to: display the association information corresponding to the keyword on an uppermost layer of the system page.

Optionally, the information display module 220 is further configured to: determine position information of the keyword, and determine a display position of the association information according to the position information of the keyword, and display the association information at the display position of the association information.

Optionally, the information display module 220 is further configured to: replace an original object node corresponding to the keyword based on an interaction object node, the interaction object node comprising the association information corresponding to the keyword; render the interaction object node in the system page.

Optionally, the information display module 220 is further configured to: in response to a preset operation, hide the association information and replace the interaction object node with the original object node corresponding to the keyword.

On the basis of the above embodiments, the apparatus further comprises: a keyword library configuration module configured to: display a keyword configuration page in response to a trigger on a display area where the association information is located; and update the preset keyword library in response to an editing on the keyword configuration page.

The information display apparatus provided by the embodiments of the present disclosure may perform the information display method provided by any embodiment of the present disclosure, and has functional modules corresponding to the execution of the methods and beneficial effects.

It should be noted that the various units and modules comprised in the foregoing apparatus are only divided according to the function logic, but are not limited to the foregoing division, as long as the corresponding functions may be implemented; in addition, the specific names of the functional units are merely for ease of distinguishing, and are not intended to limit the protection scope of the embodiments of the present disclosure.

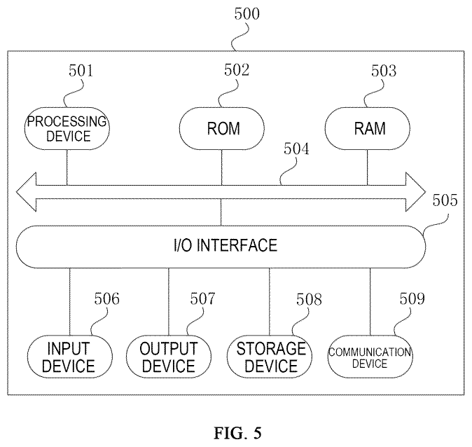

FIG. 5 is a schematic structural diagram of an electronic device provided by an embodiment of the present disclosure. References are now made to FIG. 5 which illustrates a schematic structural diagram of an electronic device (such as the terminal device or server in FIG. 5) 500 suitable for implementing the embodiments of the present disclosure. The terminal device in the embodiments of the present disclosure may include, but is not limited to, a mobile terminal such as a mobile phone, a lap top, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 5 is merely an example, and should not impose any limitation on the functions and scope of use of the embodiments of the present disclosure.

As shown in FIG. 5, the electronic device 500 may comprise a processing device (for example, a central processing unit, a graphics processor, etc.) 501, which may perform various appropriate actions and processing according to a program stored in a read-only memory (ROM) 502 or a program loaded into a random access memory (RAM) 503 from a storage device 508. There is various programs and data required by the operation of the electronic device 500 stored in the RAM 503. The processing apparatus 501, the ROM 502, and the RAM 503 are connected to each other through a bus 504. An edit/output (I/O) interface 505 is also connected to the bus 504.

Generally, the following apparatus may be connected to the I/O interface 505: an input device 506 comprising, for example, a touch screen, a touchpad, a keyboard, a mouse, a camera, a microphone, an accelerometer, a gyroscope, and the like; an output device 507 comprising, for example, a liquid crystal display (LCD), a speaker, a vibrator, and the like; a storage device 508 comprising, for example, a magnetic tape, a hard disk, and the like; and a communication device 509. The communication device 509 may allow the electronic device 500 to communicate wirelessly or wired with other devices to exchange data. While FIG. 5 shows an electronic device 500 with various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure comprise a computer program product comprising a computer program embodied on a non-transitory computer readable medium, the computer program comprising program code for performing the method shown in the flowchart. In such embodiments, the computer program may be downloaded and installed from the network through the communication device 509, or installed from the storage device 508, or from the ROM 502. When the computer program is executed by the processing apparatus 501, the foregoing functions defined in the method of the embodiments of the present disclosure are performed.

The names of messages or information exchanged between multiple apparatus in embodiments of the present disclosure are for illustrative purposes only and are not intended to limit the scope of such messages or information.

The electronic device provided by the embodiments of the present disclosure and the information display method provided in the foregoing embodiments belong to the same concept, and technical details not described in detail in this embodiment may refer to the foregoing embodiments, and this embodiment has the same beneficial effects as the foregoing embodiments.

An embodiment of the present disclosure provides a computer storage medium storing computer program that when executed by a processor implementing the information display method provided by the foregoing embodiments.

It should be noted that the computer-readable medium described above may be a computer readable signal medium, a computer readable storage medium, or any combination thereof. The computer-readable storage medium may be, for example, but not limited to, an electrical, magnetic, optical, electromagnetic, infrared, or semiconductor system, device, or apparatus, or any combination thereof. More specific examples of computer-readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, wherein the computer readable program code is carried. Such propagated data signals may be in a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate by using any currently known or future developed network protocol, such as HTTP (HyperText Transfer Protocol), and may be interconnected with digital data communication in any form or medium (e.g., a communication network). Examples of communication networks include local area networks (“LANs”), wide area networks (“WANs”), internet networks (e.g., the Internet), and peer-to-peer networks (e.g., ad hoc peer-to-peer networks), as well as any currently known or future developed networks.

The computer-readable medium described above may be included in the electronic device described above; or may be separately present without being assembled into the electronic device.

The computer-readable medium described above carries one or more programs, and when the one or more programs are executed by the electronic device, the electronic device is caused to:

The computer readable medium described above carries one or more programs, and when the one or more programs are executed by the electronic device, the electronic device is caused to: display a system page comprising a keyword and a non-keyword, wherein a preset mark is set for the keyword and the keyword is determined by matching in a preset keyword library comprising a plurality of preconfigured keywords and association information corresponding to each of the keywords; and in response to a trigger on the keyword, display the association information corresponding to the keyword in the system page.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of relating to remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the drawings illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the drawings. For example, two consecutively represented blocks may actually be performed substantially in parallel, and may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of the unit dose not limit the unit itself, for example, the first obtaining unit may be further described as “a unit obtaining at least two Internet Protocol addresses”.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The above description is merely an illustration of the preferred embodiments of the present disclosure and the principles of the application. It should be understood by those skilled in the art that the scope of disclosure related in the present disclosure is not limited to the technical solutions of the specific combination of the above technical features, and should also cover other technical solutions formed by any combination of the above technical features or their equivalent features without departing from the above disclosed concept. For example, a solution formed by mutually replacing the above features are with technical features with similar function disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either separately or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. An information display method, comprising:
displaying a system page comprising a keyword and a non-keyword, wherein a preset mark is set for the keyword and the keyword is determined by matching in a preset keyword library comprising a plurality of preconfigured keywords and association information corresponding to each of the keywords; and
in response to a trigger on the keyword, displaying the association information corresponding to the keyword in the system page.

2. The method of claim 1, wherein displaying the system page comprises:
obtaining an object node tree corresponding to the system page, the object node tree comprising a plurality of object nodes and each of the object nodes corresponding to a piece of page content;
traversing the plurality of object nodes in the object node tree, matching the piece of page content corresponding to each of the object nodes in the preset keyword library, and determining the successfully matched piece of page content as a keyword; and
rendering the plurality of object nodes in the object node tree to form the system page, wherein the preset mark is set for the keyword determined by the matching during the rendering.

3. The method of claim 2, wherein setting the preset mark for the keyword determined by the matching comprises:
creating a text area object corresponding to the keyword;
creating a mark object corresponding to the keyword; and
assigning the text area object corresponding to the keyword to the mark object corresponding to the keyword, and registering the mark object, wherein the mark object corresponds to a respective mark attribute.

4. The method of claim 2, further comprising:
monitoring a change of the object nodes corresponding to the system page, and in accordance with a determination that a number of changed object nodes exceeds a set threshold, matching pieces of page content corresponding to the changed object nodes in the preset keyword library, determining a successfully matched piece of page content as a keyword and setting a preset mark for the keyword.

5. The method of claim 4, wherein matching the pieces of page content corresponding to the changed object nodes in the preset keyword library comprises:
performing de-jitter processing on the object node to determine a de-jittered changed object node, and matching a piece of page content corresponding to the de-jittered changed object node in the preset keyword library.

6. The method of claim 1, wherein displaying the association information corresponding to the keyword in the system page comprises:
displaying the association information corresponding to the keyword on an uppermost layer of the system page.

7. The method of claim 6, further comprising:
determining position information of the keyword, determining a display position of the association information according to the position information of the keyword, and displaying the association information at the display position of the association information.

8. The method of claim 1, wherein displaying the association information corresponding to the keyword in the system page comprises:
replacing an original object node corresponding to the keyword based on an interaction object node, the interaction object node comprising the association information corresponding to the keyword; and
rendering the interaction object node in the system page.

9. The method of claim 8, further comprising:
in response to a preset operation, hiding the association information and replacing the interaction object node with the original object node corresponding to the keyword.

10. The method according to claim 1, further comprising:
in response to a trigger on a display area of the association information, displaying a keyword configuration page; and
in response to an edit on the keyword configuration page, updating the preset keyword library.

11. An electronic device, comprising:
one or more processors; and
a storage apparatus, configured to store one or more programs, the one or more programs, when executed by the one or more processors, causing the one or more processors to implement an information display method comprising:
displaying a system page comprising a keyword and a non-keyword, wherein a preset mark is set for the keyword and the keyword is determined by matching in a preset keyword library comprising a plurality of preconfigured keywords and association information corresponding to each of the keywords; and
in response to a trigger on the keyword, displaying the association information corresponding to the keyword in the system page.

12. The device of claim 11, wherein displaying the system page comprises:
obtaining an object node tree corresponding to the system page, the object node tree comprising a plurality of object nodes and each of the object nodes corresponding to a piece of page content;
traversing the plurality of object nodes in the object node tree, matching the piece of page content corresponding to each of the object nodes in the preset keyword library, and determining the successfully matched piece of page content as a keyword; and
rendering the plurality of object nodes in the object node tree to form the system page, wherein the preset mark is set for the keyword determined by the matching during the rendering.

13. The device of claim 12, wherein setting the preset mark for the keyword determined by the matching comprises:
creating a text area object corresponding to the keyword;
creating a mark object corresponding to the keyword; and
assigning the text area object corresponding to the keyword to the mark object corresponding to the keyword, and registering the mark object, wherein the mark object corresponds to a respective mark attribute.

14. The device of claim 12, wherein displaying the system page further comprises:
monitoring a change of the object nodes corresponding to the system page, and in accordance with a determination that a number of changed object nodes exceeds a set threshold, matching pieces of page content corresponding to the changed object nodes in the preset keyword library, determining a successfully matched piece of page content as a keyword and setting a preset mark for the keyword.

15. The device of claim 14, wherein matching the pieces of page content corresponding to the changed object nodes in the preset keyword library comprises:
performing de-jitter processing on the object node to determine a de-jittered changed object node, and matching a piece of page content corresponding to the de-jittered changed object node in the preset keyword library.

16. The device of claim 11, wherein displaying the association information corresponding to the keyword in the system page comprises:
displaying the association information corresponding to the keyword on an uppermost layer of the system page.

17. The device of claim 16, wherein displaying the association information corresponding to the keyword in the system page further comprises:
determining position information of the keyword, determining a display position of the association information according to the position information of the keyword, and displaying the association information at the display position of the association information.

18. The device of claim 11, wherein displaying the association information corresponding to the keyword in the system page comprises:
replacing an original object node corresponding to the keyword based on an interaction object node, the interaction object node comprising the association information corresponding to the keyword; and
rendering the interaction object node in the system page.

19. The device of claim 18, wherein displaying the association information corresponding to the keyword in the system page further comprises:
in response to a preset operation, hiding the association information and replacing the interaction object node with the original object node corresponding to the keyword.

20. A non-transitory storage medium comprising computer-executable instructions, the computer-executable instructions, when executed by a computer processor, configured to perform an information display method comprising:
displaying a system page comprising a keyword and a non-keyword, wherein a preset mark is set for the keyword and the keyword is determined by matching in a preset keyword library comprising a plurality of preconfigured keywords and association information corresponding to each of the keywords; and
in response to a trigger on the keyword, displaying the association information corresponding to the keyword in the system page.
